(19) United States
(12) Patent Application Publication
(10) Pub. No.: US 2023/0395343 A1
(43) Pub. Date: Dec. 7, 2023

(54) HEAT SWITCH DEVICE USING CRYOGENIC LOOP HEAT PIPE AND METHOD THEREFOR

(71) Applicant: KOREA AEROSPACE RESEARCH INSTITUTE, Daejeon (KR)

(72) Inventors: Hyokjin CHO, Daejeon (KR); Sangkwon JEONG, Daejeon (KR)

(21) Appl. No.: 18/249,953

(22) PCT Filed: Oct. 12, 2021
(86) PCT No.: PCT/KR2021/013957

§ 371 Date: Apr. 20, 2023

(30) Foreign Application Priority Data
Nov. 13, 2020 (KR) 10-2020-0152041

(51) Int. Cl. H01H 37/36; F28D 15/02; F28D 15/04

(52) U.S. Cl. CPC H01H 37/36; F28D 15/043; F28D 15/0266

(57) ABSTRACT

The present disclosure relates to a heat switch device using a cryogenic loop heat pipe and a method therefor, and more specifically, to a heat switch device using a cryogenic loop heat pipe and a method therefor, wherein the cryogenic loop heat pipe is configured to be operable at a cryogenic temperature, the heat switch device can perform the operation of a heat switch for heat transfer and heat blocking, by using the structure of the cryogenic loop heat pipe, without a separate heat switch, thereby reducing the weight and complexity of a system, compared to a conventional configuration, the heat switch can be operated at a user's desired time, and the heat switch device can be used even in a cryogenic environment, and performs heat exchange by using a gas-liquid phase change, thereby effectively providing high heat transfer and heat blocking effects.

### TECHNICAL FIELD

The present disclosure relates to a heat switch device using a cryogenic loop heat pipe and a method therefor, and more particularly, to a device capable of switching an operation of a heater by thermally connecting or disconnecting a heating unit and a cooling unit by using the structure and operating characteristics of a cryogenic loop heat pipe without a separate heat switch.

### BACKGROUND ART

In general, a heat switch is a device that thermally connects or disconnects a heating unit and a cooling unit, and is a device used to change the operation of heat transfer or heat blocking of a heat transfer link connected between the heating unit and the cooling unit.

The conventional heat switch includes a mechanical switch using a driving element, a switch operated by an electric relay, a bimetallic switch using a difference in coefficients of thermal expansion of different metals, a gas-gap switch that adjusts a density of a filling gas, a switch using a strength change of a memory alloy, and the like.

However, such a conventional heat switch is usually additionally installed in the middle of the heat transfer link located between the heating unit and the cooling unit, which may cause the problem of rather hindering the flow of heat in the heat transfer link, and additional devices and increasing the weight and complexity of the system due to the installation of additional devices. In addition, there may be a case in which separate power should be consumed for operation, and when the thermal conductivity of the heat transfer link is not sufficient, a separate actuator should be further provided to drive the device, making the device complicated while using more power. Accordingly, there is a disadvantage in that it is not easy to maintain and repair the device. In addition, in the case of not consuming power, since the operating temperature at which the switch is operated is generally fixed, there is a disadvantage in that the switch may not operate at a user's desired time other than the operating temperature.

In addition, the heat switch is provided as necessary between a cryogenic heating element that is operated at a cryogenic temperature of −150° C. or lower and generates heat, such as an infrared detector of a spacecraft, and a cryogenic refrigerator or a cryogenic heat sink that cools the cryogenic heating element. There is a problem in that the conventional heat switch may improve the weight and complexity of the system and cause energy inefficiency. Since the conventional heat switch has a fixed operating temperature, there is a problem in that the conventional heat switch may not be used according to the user's convenience while turning on/off the power supply of the heat transfer link in the case where there is an object that needs to be cooled or according to the situation.
(Related Art Patent Document 1) Korean Patent Publication No. 10-1357488 “Test Assistive Device and Method for Thermostat for Heater Control Harness for Continuity Check Test (2014.01.23.)”

### DISCLOSURE

### Technical Problem

An object of the present disclosure provides a heat switch device using a cryogenic loop heat pipe and a method therefor, in which a heat switch for controlling a power supply of a heat transfer link that is provided in a spacecraft and needs to be driven in a cryogenic environment uses a cryogenic loop heat pipe as the heat transfer link, and is configured to be able to switch the power supply only with a simple operation without a separate heat switch device by using a structure of the cryogenic loop heat pipe provided in the spacecraft to provide high heat transfer and heat transfer blocking effects.

### Technical Solution

In one general aspect, a heat switch device using a cryogenic loop heat pipe provided in a spacecraft includes: a heating unit; a cooling unit; the cryogenic loop heat pipe in which a working fluid accommodated therein is circulated and which connects between the heating unit and the cooling unit to exchange heat, and including a first evaporator connected to the heating unit, a condenser connected to the cooling unit, a liquid transfer pipe connecting between the first evaporation and the condenser to move liquids of the first evaporator and the condenser, and a steam transfer pipe connecting between the first evaporator and the condenser to move gases of the first evaporator and the condenser; a second evaporator connected to the condenser; and a heater heating the second evaporator.

The heat switch device may further include a power supply unit supplying power to the heater.

The first evaporator and the second evaporator may be configured to include a compensation chamber formed on one side to store the inflowing working fluid, a wick through which the working fluid of the compensation chamber passes, and a steam discharge channel formed on the other side to discharge steam evaporated from the wick to an outside.

The heat switch device may further include: a refrigerator contacting a portion where the compensating chamber of the second evaporator is accommodated and the condenser.

The heater may be provided in a portion where the wick of the second evaporator is accommodated.

The working fluid of the loop heat pipe may be a gas containing at least one of nitrogen, oxygen, neon, and helium gases.

The first evaporator and the second evaporator may further include an auxiliary transfer pipe through which the liquid and steam moves.

The auxiliary transfer pipe may move the working fluid of the first evaporator to the second evaporator.

In another general aspect, a heat switch method by the heat switch device using a cryogenic loop heat pipe includes: a working fluid filling step of filling the loop heat pipe with a working fluid of a gas; a refrigerator operation step of operating a refrigerator connected to a partial area of the second evaporator and the condenser to cool the second evaporator and the condenser to form a liquefied working fluid; a heater operation step of heating the second evaporator by supplying power to the heater from the outside; a liquid transfer pipe flow step in which a volume of the liquefied working fluid is expanded due to evaporation generated by heating of the second evaporator to make the liquefied working fluid inside the condenser flow in the first evaporator along the liquid transfer pipe by expanding; a heat absorbing step from a heating unit in which the liquefied working fluid flows into the first evaporator and the first evaporator absorbs the heat from the heating unit; and a steam transfer pipe flow step in which the first evaporator vaporizes the liquefied working fluid by heat absorption, and the formed steam is moved to the condenser along the steam transfer pipe.

After the steam transfer pipe flow step, the heater operation step may be performed.

The heat switch method may further include, after the steam transfer pipe flow step, performing a power cutoff step of cutting off the power supplied to the heater.

The working fluid may be a gas containing at least one of nitrogen, oxygen, neon, helium gases.

### Advantageous Effects

According to the heat switch device using the cryogenic loop heat pipe and the method therefor of the present disclosure having the configuration as described above, it is possible to reduce the weight and complexity of the system compared to the conventional configuration and operate the heat switch at the user's desired time by performing the operation of the heat switch that performs heat transfer and heat blocking using the structure and operating characteristics of the cryogenic loop heat pipe without a separate heat switch, and it is possible to effectively achieve high heat transfer and heat blocking effects by performing heat exchange using a gas-liquid phase change.

### BRIEF DESCRIPTION OF THE DRAWINGS

FIG. 1 is a block diagram of the present disclosure.

FIG. 2 is a partial block diagram 1 of the present disclosure.

FIG. 3 is a partial block diagram 2 of the present disclosure.

FIG. 4 is a method flow chart 1 of the present disclosure.

FIG. 5 is a method flow chart 2 of the present disclosure.

### BEST MODE

Hereinafter, the technical spirit of the present disclosure will be described in more detail with reference to the accompanying drawings. Terms and words used in the present specification and claims are not to be construed as a general or dictionary meaning, but are to be construed as meaning and concepts meeting the technical ideas of the present disclosure based on a principle that the present inventors may appropriately define the concepts of terms in order to describe their inventions in best mode.

Therefore, configurations described in exemplary embodiments and the accompanying drawings of the present disclosure do not represent all of the technical spirits of the present disclosure, but are merely most preferable embodiments. Therefore, the present disclosure should be construed as including all the changes, and substitutions included in the spirit and scope of the present disclosure at the time of filing this application.

Hereinafter, the technical spirit of the present disclosure will be described in more detail with reference to the accompanying drawings. However, the accompanying drawings are only examples shown in order to describe the technical idea of the present disclosure in more detail. Therefore, the technical idea of the present disclosure is not limited to shapes of the accompanying drawings.

The present disclosure is to provide a heat switch that is provided inside a spacecraft and can be used even in a cryogenic environment. The heat switch is a device that allows a heat exchange link, which is located between a heating unit 10 and a cooling unit 20 to perform heat exchange, to serve as a thermal conductor and an insulator. The present disclosure provides a heat switch device using a cryogenic loop heat pipe and a method therefor, in which the heat switch device performs an operation of the switch using a structure and operating characteristics of the cryogenic loop heat pipe that connects the heating unit 10 and the cooling unit 20 to exchange heat without a separate heat switch device or blocks a connection between the heating unit 10 and the cooling unit 20 to perform an operation of heat blocking.

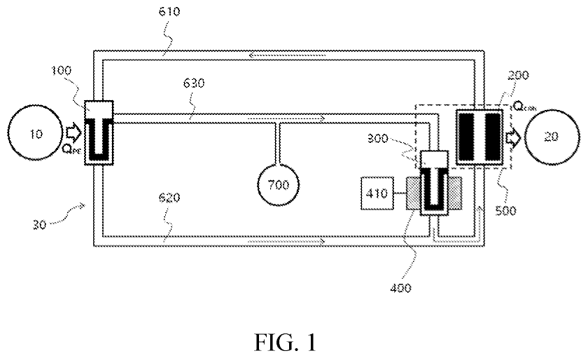

Accordingly, referring to FIG. 1, the present disclosure relates to a switch device using a cryogenic loop heat pipe 30 provided in a part requiring heat exchange such as a spacecraft. The switch device is configured to include a heating unit 10, which is a part that needs to be cooled at the time of generating heat beyond a certain temperature, a cooling unit that is formed at a lower temperature than the heating unit 10 and cools the heating unit 10 by heat exchange, and a cryogenic loop heat pipe 30 connecting the heating unit 10 and the cooling unit 20 to exchange heat with each other. The cryogenic loop heat pipe 30 includes a first evaporator 100 connected to the heating unit 10, a condenser 200 connected to the cooling unit 20, a liquid transfer pipe 610 connecting between the first evaporator 100 and the condenser 200 to be able to move liquids of the first evaporator 100 and the condenser 200, and a steam transfer pipe 620 connecting between the first evaporator 100 and the condenser 200 to be able to move gases of the first evaporator 100 and the condenser 200. In this case, the heat switch device according to the present disclosure is configured to further include a second evaporator 300 connected to the condenser 200 and a heater 400 heating the second evaporator 300.

Referring to FIG. 1, the cryogenic loop heat pipe 30 connects between the heating unit 10 and the cooling unit 20 and has a working fluid accommodated therein, and is configured so that a working fluid accommodated therein is circulated between the heating unit and the cooling unit 20 to exchange heat. The first evaporator 100 is a primary evaporator of the present disclosure, and is preferably located near the heating unit 10 and connected to receive heat from the heating unit 10. In additional, The condenser 200 is located near the cooling unit 20 and connected to the cooling unit 20 to discharge heat transferred by circulation of the working fluid to the cooling unit 20.

The first evaporator 100 has a working fluid accommodated therein, and the first evaporator 100 receives heat from the heating unit 10 connected to the first evaporator 100 to heat the first evaporator 100. The first evaporator 100 may have liquefied working fluid accommodated therein, the first evaporator 100 is heated by the heat transferred by the heating unit 10, and by a phenomenon in which the working fluid accommodated in the first evaporator 100 absorbs heat and is vaporized, that is, as the liquefied working fluid is phase-changed into a gas, heat transferred to the first evaporator 100 is transferred to the outside of the first evaporator 100 through vapor.

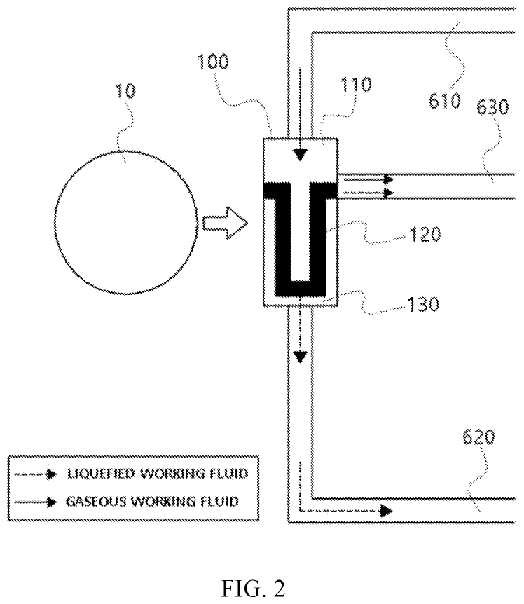

Referring to FIG. 2 in more detail, the first evaporator 100 may be configured to include a compensation chamber 110 formed to store the working fluid inflowing from one side, a porous wick 120 that generates capillary force by the vaporized working fluid, and a steam discharge channel 130 that discharges the evaporated steam to the outside of the first evaporator 100 on the other side.

The compensation chamber 110 is configured at a position where the working fluid flows into the first evaporator 100 in a liquid state, stores the working fluid so that the liquefied working fluid may be supplied to the first evaporator 100 with a certain capacity or more and maintains the working fluid in a saturated state. As long as the compensation chamber 110 is formed to store the working fluid, the compensation chamber 10 may be configured regardless of a shape.

The wick 120 is formed of a porous material. The shape of the wick 120 may not be limited as long as the wick 120 is in contact with the compensation chamber 110 to vaporize the working fluid of the liquid supplied to the compensation chamber 110 in the wick 120 and discharge the generated steam to the steam discharge channel 130. The wick 120 is preferably formed in a shape that surrounds or engages the shape of the compensation chamber 110.

The steam discharge channel 130 is formed to discharge the vaporized steam to the outside of the first evaporator 100, and is preferably located on the outer circumferential surface of the wick 120. The steam discharge channel 130 is preferably formed so that the steam evaporated from the wick 120 on one side is discharged to the outside through the other side of the first evaporator 100, and the steam discharge channel 130 is preferably formed so that the working fluids accommodated by the compensation chamber 110 and the wick 120 are divided not to be mixed.

Accordingly, in the first evaporator 100, when the liquefied working fluid is stored in the compensation chamber 110 and the first evaporator 100 is heated by receiving heat from the heating unit 10, the liquefied working fluid in the wick 120 is vaporized by heat to generate vapor, and the steam out of the wick 120 is moved to the outside of the first evaporator 100 along the steam discharge channel 130. In this case, the first evaporator 100 is connected to the liquid transfer pipe 610 so that the working fluid in liquid state is introduced, and is connected to the steam transfer pipe 620 so that the gaseous working fluid is discharged, thereby moving the liquefied and gaseous working fluid. In more detail, it is preferable that one side of the first evaporator 100 is connected to the liquid transfer pipe 610 and the liquid transfer pipe 610 is connected to the compensation chamber 110 of the first evaporator 100, so the liquid transferred through the liquid transfer pipe 610 is accommodated in the compensation chamber 110, and the other side of the first evaporator 100 is connected to the steam transfer pipe 620 of the first evaporator 100 and the steam transfer pipe 620 is connected to the steam discharge channel 130, so the steam vaporized in the first evaporator 100 is moved through the steam transfer pipe 620.

The condenser 200 is provided to condense the gaseous working fluid accommodated therein, the gaseous working fluid accommodated in the cryogenic loop heat pipe 30 may be moved to the condenser 200, the condenser 200 condenses the steam accommodated in the condenser 200 to change the phase to a liquid, and is configured to take heat from the working fluid and transfer the heat to the outside. In this case, it is preferable that the condenser 200 is configured to be connected to the cooling unit 20 to take heat from the working fluid and transfer the heat to the cooling unit 20. In addition, the condenser 200 may include a refrigerator 500 to cool the condenser 200 to a temperature below a certain level, and the refrigerator 500 is configured to be positioned in contact with the condenser 200, so the condenser 200 may be cooled by the refrigerator 500 and configured to condense the gaseous working fluid accommodated in the condenser 200 to change the phase of the gaseous working fluid.

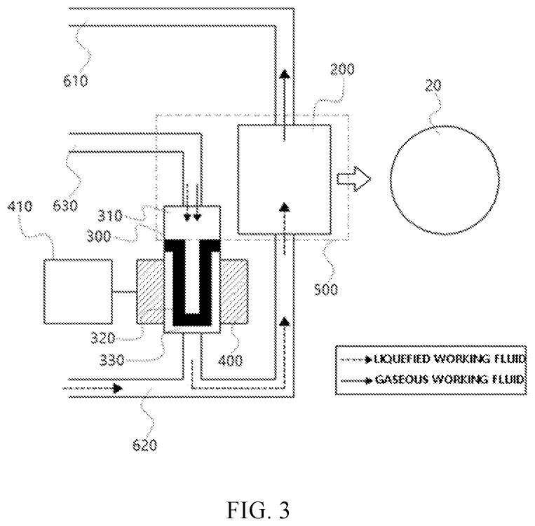

Referring to FIG. 3 in more detail, the condenser 200 is formed to transfer the working fluid of the liquid generated by condensing the working fluid of the accommodated gas to the first evaporator 100, and is also formed so that the working fluid of the gas generated in the first evaporator 100 and the second evaporator 300 flows into the condenser 200. In this case, it is preferable that the condenser 200 is connected to the liquid transfer pipe 610 and the steam transfer pipe 620, respectively, to transfer the working fluid of the liquid generated by the condenser 200 to the first evaporator 100 through the liquid transfer pipe 610 and transfer the working fluid of the steam generated by the first evaporator 100 to the condenser 200 through the steam transfer pipe 620.

As illustrated in FIG. 1, the steam transfer pipe 620 and the liquid transfer pipe 610 connect the first evaporator 100 and the condenser 200 so that the working fluid accommodated in the device of the cryogenic loop heat pipe 30 may be circulated and the steam transfer pipe 620 and the liquid transfer pipe 610 may be used without limitation as long as they are provided inside the cryogenic loop heat pipe 30 and formed to move the phase-changing working fluid. In this case, since the directions in which the liquefied working fluid and the gaseous working fluid flow are opposite to each other, it is preferable that the steam transfer pipe 620 is formed so that the working fluid of the steam is moved, and the liquid transfer pipe 610 is formed so that the liquefied working fluid is moved, thereby separately moving the liquefied working fluid and the gaseous working fluid. The steam transfer pipe 620 and the liquid transfer pipe 610 connect the condenser 200 and the first evaporator 100, so the heating unit 10 and the cooling unit 20 may continuously exchange heat.

For example, when any one of both ends of the liquid transfer pipe 610 is connected to one side of the first evaporator 100, the condenser 200 is configured so that the other of both ends of the liquid transfer pipe 610 is connected to one side of the condenser 200 in the same direction as the first evaporator 100, that is, on one side of the condenser 200, so the liquefied working fluid formed in the condenser 200 may be moved to the first evaporator 100. In addition, when any one of both ends of the steam transfer pipe 620 is connected to the other side of the first evaporator 100, the other of both ends of the steam transfer pipe 620 is connected to the other side of the condenser 200, so the gaseous working fluid formed in the first evaporator 100 may be moved to the condenser 200. In this case, the direction of the working fluid moving in the liquid transfer pipe 610 and the steam transfer pipe 620 may be formed to flow in opposite directions to each other, and it is preferable that the liquid transfer pipe 610 and the steam transfer pipe 620 is formed of pipes having appropriate diameters in consideration of a flow rate in order to efficiently transfer the liquid and gaseous working fluids over a longer distance.

In the present disclosure, the second evaporator 300 is further provided in the cryogenic loop heat pipe 30 including the first evaporator 100, the condenser 200, the liquid transfer pipe 610, and the steam transfer pipe 620, and the second evaporator 300 is a secondary evaporator according to the present disclosure and is preferably connected to the condenser 200 to transfer the steam as the working fluid to the condenser 200. The second evaporator 300 may have the working fluid accommodated in the second evaporator 300, and is configured to heat the working fluid inside the second evaporator 300 by heat generated from the heater 400. The heater 400 may be provided regardless of shape as long as it is formed to heat the second evaporator 300. For example, the heater 400 may be formed as an attachable heater 400 to be attached to the outer circumferential surface of the second evaporator 300, and may be formed to generate heat when supplied with power from the outside to heat the second evaporator 300.

The second evaporator 300 has a working fluid accommodated therein, and the second evaporator 300 receives heat from the heater 400 connected to the second evaporator 300 to heat the second evaporator 300. The second evaporator 300 may have the liquefied working fluid accommodated therein, the second evaporator 300 is heated by the heat transferred by the heating unit 10, and by a phenomenon in which the working fluid accommodated in the second evaporator 300 absorbs heat and is vaporized, that is, as the liquefied working fluid is phase-changed into a gas, heat transferred to the first evaporator 100 is transferred to the outside of the second evaporator 300 through vapor.

Referring to FIG. 3 in more detail, like the first evaporator 100 described above, the second evaporator 300 may be configured to include a compensation chamber 310 formed to store the working fluid flowing into one side, a wick 320 through which the liquid inflowing by the vaporized working fluid passes, and a steam discharge channel 330 discharging steam out of the wick 320 to the outside of the second evaporator 300 on the other side, and may be configured to include the compensation chamber 310, the wick 320, and the steam discharge channel 330 having the same characteristics as the compensation chamber 110, the wick 120, and the steam discharge channel 130 of the first evaporator 100.

The second evaporator 300 may be configured to receive a liquefied working fluid from an external device, but the present disclosure uses the cryogenic loop heat pipe 30, and is formed of a closed circuit so the working fluid is circulated therein. Accordingly, the second evaporator 300 may be connected to the first evaporator 100 through an auxiliary transfer pipe 630, and the auxiliary transfer pipe 630 connects between the second evaporator 300 and the first evaporator 100 so that the working fluid is received from the first evaporator 100. The auxiliary transfer pipe 630 is a component configured to move the working fluid more smoothly when the cryogenic loop heat pipe 30 is operated in a cryogenic environment. When the second evaporator 300 is configured to include the structure of the wick 320, the second evaporator 300 is heated by the heater 400, so capillary force is generated by the structure of the wick 320 of the second evaporator 300. The gaseous working fluid stored inside the first evaporator 100 is moved by the capillary force, and flows into the compensating chamber 310 of the second evaporator 300 along the auxiliary transfer pipe 630 together with a small amount of liquefied working fluid. Therefore, the first evaporator 100, the second evaporator 300, and the condenser 200 are constituted as a closed circuit by the liquid transfer pipe 610, the gas transfer tube, and the auxiliary transfer pipe 630, so the working fluid therein is smoothly circulated and moved, thereby transferring heat from the heating unit 10 to the cooling unit 20.

Also, referring to FIG. 1, the auxiliary transfer pipe 630 may include a tank 700 connected to any one portion of the longitudinal direction of the auxiliary transfer pipe 630. When the tank 700 is filled with a sufficient amount of gas at room temperature before operating the refrigerator 50 so that a sufficient liquid may be generated in the cryogenic loop heat pipe 30 at a cryogenic operating temperature, it is preferable that the tank 700 continuously communicates with the cryogenic loop heat pipe 30 to prevent an excessive increase in internal pressure. The tank 700 may be configured to supply a working fluid until the pressure inside the cryogenic loop heat pipe 30 reaches equilibrium according to the operating conditions of the cryogenic loop heat pipe 30.

Referring to FIG. 3, the second evaporator 300 may be configured so that one side of the second evaporator 300 where the compensation chamber 310 is located and the first evaporator 100 are connected through the auxiliary transfer pipe 630 to move the working fluid stored in the first evaporator 100 to the second evaporator 300. The steam discharge channel 330 of the second evaporator 300 is connected to the condenser 200 to transfer the steam generated from the heater 400 in the second evaporator 300 to the condenser 200. In this case, the steam discharge channel 330 of the second evaporator 300 may be connected to the condenser 200 by a separate transfer pipe to transfer steam. However, the portion of the steam discharge channel 330 of the second evaporator 300 is connected to the steam transfer pipe 620 near the condenser 200, so the heating of the second evaporator 300 evaporates the liquefied working fluid, and the volume expansion due to the evaporation causes the liquefied working fluid accommodated in the condenser 200 to be moved to the first evaporator 100.

The second evaporator 300 is configured so that the refrigerator 500 is in contact with the portion where the compensation chamber 310 of the second evaporator 300 stores the working fluid transferred from the first evaporator 100 is formed, and by attaching the heater 400 to an area of the second evaporator 300 that is not in contact with the refrigerator 500, the second evaporator 300 is configured to be in contact with both the heater 400 and the refrigerator 500. In the present disclosure, a gas that is liquefied at a cryogenic temperature, such as nitrogen, oxygen, neon, and helium gases, may be used as a working fluid in order to perform heat exchange in a cryogenic environment, and the working fluid stays in a gaseous state at room temperature. In this case, in order to change the phase of the working fluid such as nitrogen gas in the condenser 200 to a liquid and then transfer the liquid to the first evaporator 100, the heater 400 generates heat and the evaporation is made in the second evaporator 300. In order for the second evaporator 300 to operate, the liquefied working fluid should be stored in the compensation chamber 310 of the second evaporator 300.

To perform this, the refrigerator 500 cooling the condenser 200 is configured to be in contact with the compensating chamber 310 of the second evaporator 300, so the nitrogen gas inside the second evaporator 300 is cooled by the cooler and phase-changed to a liquid. The second evaporator 300, which generates the liquefied working fluid, is heated by the operation of the heater 400, so the volume expansion due to evaporation occurs. The liquid working fluid of the condenser 200 is moved to the first evaporator 100 along the liquid transfer pipe 610 by the volume expansion to fill the compensation chamber 110 of the first evaporator 100 with the liquefied working fluid, so the first evaporator 100 is heated by the heating unit and the cryogenic loop heat pipe 30 performs heat exchange between the heating unit 10 and the cooling unit 20. In this case, since the second evaporator 300 evaporates the liquefied working fluid by external heating, the heater 400 is attached to an area not in contact with the cooling unit 20, so the second evaporator 300 evaporates the liquid generated by the refrigerator 500.

Accordingly, in order to efficiently operate the cryogenic loop heat pipe 30 at a cryogenic temperature, the first evaporator 100, the second evaporator 300, and the condenser 200 are connected to each other by the liquid transfer pipe 610, the steam transfer pipe 620 and the auxiliary transfer pipe 630 to have the above characteristics. In addition, the refrigerator 500 and the condenser 200 are provided to be in contact with a partial area of the second evaporator 300 and the heater 400 is attached to the remaining area where the second evaporator 300 is not in contact with the cooling unit 20. By operating the refrigerator 500 and the heater 400, the cryogenic loop heat pipe 30 performs the heat exchange operation.

In this case, the heat switch device using the cryogenic loop heat pipe 30 of the present disclosure performs a switch operation using the structure and operating characteristics of the cryogenic loop heat pipe 30 without separately installing a switch device provided to connect and cut off the power supply of the cryogenic loop heat pipe 30 that performs the heat exchange operation. Accordingly, the present disclosure includes a power supply unit 410 that adjusts the power supply of the heater 400. In the cryogenic loop heat pipe 30, since the liquefied working fluid should be generated inside the second evaporator 300 and the cryogenic loop heat pipe 30 is operated by evaporating the liquefied working fluid, according to the present disclosure, the power supply of the cryogenic loop heat pipe 30 may be turned on by supplying power to the heater 400 using the power supply unit 410, and when the operation of the second evaporator 300 is required because the normal operating state may not be maintained only by the capillary force of the first evaporator 100, the power supply of the cryogenic loop heat pipe 30 may be turned off by cutting off the power to the heater 400 using the power supply unit 410.

The power supply unit 410 is a device that supplies power to the heater 400. The heater 400 may be operated or stopped by the power supply unit 410, and the supplied power may be adjusted to control the heated temperature. When the heater 400 is a self-heating device having its own power supply, the power supply unit 410 may be formed as a device that connects or blocks heat exchange between the heater 400 and the second evaporator 300. The power supply unit 410 may be formed as a device such as a power supply to supply power to the heater 400 according to an input value input from the outside.

Referring to FIG. 3 in more detail, when the power supply unit 410 supplies power to the heater 400, the heater 400 evaporates the liquefied working fluid formed in the second evaporator 300, the liquefied working fluid of the condenser 200 is moved to the first evaporator 100, and when the liquefied working fluid moved to the inside of the first evaporator 100 is moved and wets the wick 120 of the first evaporator 100, the first evaporator 100 receives heat from the heating unit 10 and is heated, so the circulation of the working fluid is performed and the heat exchange of the cryogenic loop heat pipe 30 is performed. On the other hand, when the power supply unit 410 cuts off power to the heater 400, the first evaporator 100 continuously receives the heat of the heating unit 10 by the liquefied working fluid inside the first evaporator 100, so the evaporation continuously occurs in the first evaporator 100, whereas the power supply of the heater 400 is turned off, and the evaporation does not occur in the second evaporator 300. Therefore, since the volume expansion due to the evaporation does not occur, the flow rate of the liquefied working fluid cooled in the condenser 200 to the first evaporator 100 is reduced. When the capillary force of the first evaporator 100 itself is not sufficient in the first evaporator 100 as the liquid is not sufficiently supplied to the inside of the first evaporator 100 continuously heated by the heating unit 10, a dry-out phenomenon occurs, so the first evaporator 100 no longer absorbs the heat of the heating unit 10 and the working fluid is not circulated, thereby stopping the heat exchange operation of the cryogenic loop heat pipe 30.

Therefore, the heat switch device using the cryogenic loop heat pipe 30 of the present disclosure may perform the power switch operation of the cryogenic loop heat pipe 30 through the operation of supplying or cutting off power to the heater 400 without additionally installing a separate device in the cryogenic loop heat pipe 30, so the system may be lightweight and be configured more simply, thereby providing ease of maintenance and repair of the system. In addition, the conventional switch may perform the power switch operation only at a predetermined temperature, but the present disclosure may actively operate when a user wants to turn on or off the power of the cryogenic loop heat pipe 30. In addition, since the present disclosure is configured to be easily operated at a cryogenic temperature, nitrogen gas or the like may be used as a working fluid. When the switch is turned on, effective thermal conductivity of 1000 W/m-K or more is implemented by nitrogen gas, but when the switch is turned off, only the thermal conductivity by the metal line constituting the cryogenic loop heat pipe 30 is implemented, so it is possible to effectively turn on or off the operation of the cryogenic loop heat pipe 30 by the difference in thermal conductivity caused by the turn on or off of the switch.

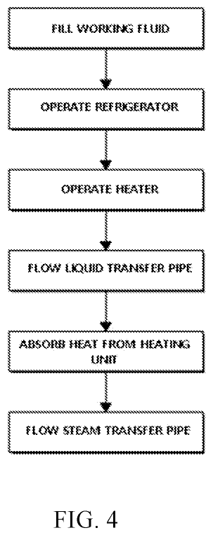

Referring to FIG. 4, the switching method by the heat switch device using the cryogenic loop heat pipe 30 includes a working fluid filling step, a refrigerator operation step, a heater operation step, a liquid transfer pipe flow step, a heat absorbing step from a heating unit, and a steam transfer pipe flow step.

In the working fluid filling step, the gaseous working fluid is filled in the cryogenic loop heat pipe 30, and in the refrigeration operation step, the refrigerator 500 connected to the partial area of the second evaporator 300 and the condenser 200 is operated to cool the working fluid of the gas accommodated in the second evaporator 300 and the condenser 200 to form the liquefied working fluid. In addition, in the heater operation step, power is provided to the heater 400 to heat the second evaporator 300, and power is supplied and cut off to the heater by the power supply unit 410, and in the liquid transfer pipe flow step, the volume is expanded according to the evaporation generated by the heating of the second evaporator 300, so the liquefied working fluid in the condenser 200 is moved to the first evaporation 100 along the liquid transfer pipe 610. In the step of absorbing the heat from the heating unit, due to the liquid transfer pipe flow step, the liquefied working fluid flows into the first evaporator 100 through the liquid transfer pipe 610, and the first evaporator 100 absorbs the heat from the heating unit 10, and in the steam transfer pipe flow step, the first evaporator 100 is heated by absorbing the heat from the heating unit 10, and the steam formed as the liquefied working fluid accommodated in the first evaporator 100 is vaporized is moved to the condenser 200 along the steam transfer pipe 620. By operating through the above steps, the heating unit 10 and the cooling unit 20 may exchange heat with each other.

In this case, the present disclosure relates to the heat switch device of the cryogenic loop heat pipe 30 that can be driven even in the cryogenic environment. The working fluid flowing in the cryogenic loop heat pipe 30 is a gas that is liquefied at the cryogenic temperature, such as nitrogen, oxygen, neon, and helium gases. The heat switch device is configured to include the second evaporator 300, the heater 400, and the auxiliary transfer pipe 630 to operate the cryogenic loop heat pipe 30 at the cryogenic temperature. The power supply of the cryogenic loop heat pipe 30 may be turned on/off by adjusting the power supplied to the heater 400 through the power supply unit 410.

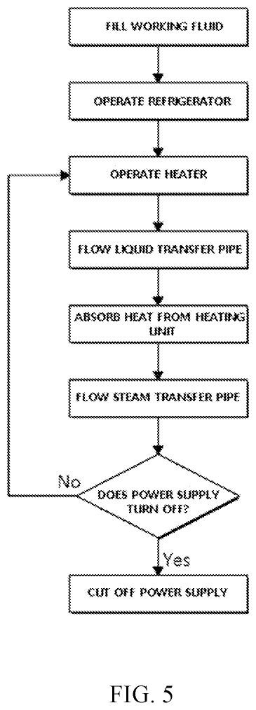

Referring to FIG. 5, the first evaporator 100 is connected to the second evaporator 300 through the auxiliary transfer pipe 630, and the first evaporator 100 and the second evaporator 300 are configured to include the compensation chambers 110 and 310, the wicks 120 and 320, and the vapor discharge channels 130 and 330. Accordingly, in the step of absorbing heat from the heating unit, as the first evaporator 100 and the second evaporator 300 are heated together, the capillary force is generated by the structure of the wick 320 of the second evaporator 300. Therefore, after the step of absorbing heat from the heating unit, the auxiliary transfer pipe flow step in which the working fluid stored in the compensation chamber 110 of the first evaporator 100 is moved to the second evaporator 300 along the auxiliary transfer pipe 630 is performed. Therefore, after the step of absorbing heat from the heating unit, the steam transfer pipe flow step and the step of absorbing heat from the heating unit 10 may be performed simultaneously, and the working fluid is moved and circulated to the components in the cryogenic loop heat pipe 30 to exchange heat between the heating unit 10 and the cooling unit 20.

Referring to FIG. 5, in order to continuously operate the cryogenic loop heat pipe 30 in a turn on state, according to the present disclosure, the heater operation step is performed after the steam transfer pipe flow step. As the heater operation step is performed again after the steam transfer pipe flow step, power is supplied to the heater 400 again, and the heater 400 generates heat. Since the heater 400 continuously heats the second evaporator 300 and moves the working fluid of the condenser 200 to the first evaporator 100 and circulates the working fluid, the working fluid may move between the heat generating unit 10 and the cooling unit 20 and may continuously perform heat exchange.

Referring to FIG. 5, in order to stop the operation of the cryogenic loop heat pipe 30 in the turn off state, according to the present disclosure, after the steam transfer pipe flow step, a power cutoff step of cutting off the power supplied to the heater 400 is performed. The power cutoff step may be performed by the power supply unit 410 supplying power to the heater 400, and may be performed by the power supply unit 410 stopping power supply to the heater 400. By the power cutoff step, the heater 400 does not generate heat, and the evaporation stops in the second evaporator 300, so the flow rate of the liquefied working fluid generated in the condenser 200 to the first evaporator 100 is reduced. Accordingly, the first evaporator 100 is continuously heated by the heating unit 10, and the liquefied working fluid accommodated in the first evaporator 100 continues to evaporate, thereby causing the dry-out phenomenon and stopping the circulation of the working fluid. Accordingly, in the cryogenic loop heat pipe 30, performing the heat exchange stops by the working fluid, and only the heat exchange by the pipe case of the cryogenic loop heat pipe 30 is performed. However, the cryogenic loop heat pipe 30 of the present disclosure should be operated at a very low temperature, and a difference between the thermal conductivity by the metal constituting the pipe case and the thermal conductivity by nitrogen gas is a difference in thermal conductivity ratio between a minimum of hundreds and thousands or more, thereby obtaining the state in which the cryogenic loop heat pipe 30 is turned off by the difference in thermal conductivity.

Hereinabove, although the present disclosure has been described by specific matters such as detailed components, exemplary embodiments, and the accompanying drawings, they have been provided only for assisting in the entire understanding of the present disclosure. Therefore, the present disclosure is not limited to the exemplary embodiments. Various modifications and changes may be made by those skilled in the art to which the present disclosure pertains from this description.

Therefore, the spirit of the present disclosure should not be limited to these exemplary embodiments, but the claims and all of modifications equal or equivalent to the claims are intended to fall within the scope and spirit of the present disclosure.

### DESCRIPTION OF REFERENCE SIGNS

10: Heat dissipation unit
20: Cooling unit
30: Heat pipe
100: First evaporator
200: Condenser
300: Second evaporator
110, 310: Compensation chamber
120, 320: Wick
130, 330: Steam discharge channel
400: Heater
410: Power supply unit
500: Refrigerator
610: Liquid transfer pipe
620: Steam transfer pipe
630: Auxiliary transfer pipe
700: Tank

1. A heat switch device using a cryogenic loop heat pipe provided in a spacecraft, comprising:
a heating unit;
a cooling unit;
the cryogenic loop heat pipe in which a working fluid accommodated therein is circulated and which connects between the heating unit and the cooling unit to exchange heat, and including a first evaporator connected to the heating unit, a condenser connected to the cooling unit, a liquid transfer pipe connecting between the first evaporation and the condenser to move liquids of the first evaporator and the condenser, and a steam transfer pipe connecting between the first evaporator and the condenser to move gases of the first evaporator and the condenser;
a second evaporator connected to the condenser; and
a heater heating the second evaporator.

2. The heat switch device of claim 1, further comprising:
a power supply unit supplying power to the heater.

3. The heat switch device of claim 1, wherein the first evaporator and the second evaporator are configured to include a compensation chamber formed on one side to store the inflowing working fluid, a wick through which the working fluid of the compensation chamber passes, and a steam discharge channel formed on the other side to discharge steam evaporated from the wick to an outside.

4. The heat switch device of claim 3, further comprising:
a refrigerator contacting a portion where the compensating chamber of the second evaporator is accommodated and the condenser.

5. The heat switch device of claim 3, wherein the heater is provided in a portion where the wick of the second evaporator is accommodated.

6. The heat switch device of claim 1, wherein the working fluid of the loop heat pipe is a gas containing at least one of nitrogen, oxygen, neon, and helium gases.

7. The heat switch device of claim 1, wherein the first evaporator and the second evaporator further include an auxiliary transfer pipe through which the liquid and steam moves.

8. The heat switch device of claim 7, wherein the auxiliary transfer pipe moves the working fluid of the first evaporator to the second evaporator.

9. A heat switch method by the heater switch device using a cryogenic loop heat pipe of claim 1, the heat switch method comprising:
a working fluid filling step of filling the loop heat pipe with a working fluid of a gas;
a refrigerator operation step of operating a refrigerator connected to a partial area of the second evaporator and the condenser to cool the second evaporator and the condenser to form a liquefied working fluid;
a heater operation step of heating the second evaporator by supplying power to the heater from the outside;
a liquid transfer pipe flow step in which a volume of the liquefied working fluid is expanded due to evaporation generated by heating of the second evaporator to make the liquefied working fluid inside the condenser flow in the first evaporator along the liquid transfer pipe by expanding;
a heat absorbing step from a heating unit in which the liquefied working fluid flows into the first evaporator and the first evaporator absorbs the heat from the heating unit; and
a steam transfer pipe flow step in which the first evaporator vaporizes the liquefied working fluid by heat absorption, and the formed steam is moved to the condenser along the steam transfer pipe.

10. The heat switch method of claim 9, wherein after the steam transfer pipe flow step, the heater operation step is performed.

11. The heat switch method of claim 9, further comprising:
after the steam transfer pipe flow step, performing a power cutoff step of cutting off the power supplied to the heater.

12. The heat switch method of claim 9, wherein the working fluid is a gas containing at least one of nitrogen, oxygen, neon, helium gases.
